(19) United States
(12) Patent Application Publication
(10) Pub. No.: US 2004/0006515 A1
(43) Pub. Date: Jan. 8, 2004

(54) Method for supplying framing materials

(76) Inventors: Curtis S. Brey, South Windsor, CT (US); Gary E. Lee, Farmington, CT (US); David W. Craig, Newington, CT (US); Matthew R. French, Marietta, GA (US); Blair F. Tomalonis, Enfield, CT (US); Shawn Duchesneau, Unionville, CT (US); Steven A. Jackson, Windsor Locks, CT (US)

Correspondence Address: McCormick, Paulding & Huber, City Place II, 185 Asylum Street, Hartford, CT, 06103-3402, US

(21) Appl. No.: 10/188,903

(22) Filed: Jul. 3, 2002

(51) Int. Cl. G06F 17/60

(52) U.S. Cl. 705/26

(57) ABSTRACT

A method for supplying framing materials is provided, comprising the steps of: (a) providing a framer access to a software program for selecting one or more characteristics of a framing supply such as a mat board, wherein the software program is operable to create an electronic file that contains information relating to the one or more characteristics; (b) receiving one or more of the electronic files that contain the information relating to the characteristics of one or more mat boards; (c) preparing the framing material using a computer controlled machine and the one or more electronic files; and (d) providing the framing material to the framer.

### BACKGROUND OF THE INVENTION

1. Technical Field

This invention relates to business methods for providing framing materials in general, and to methods for providing customized framing materials in particular.

2. Background Information

Picture framing businesses (“framers”) provide framing services and materials to end-users. The end-user selects a framing material, such as a mat board, and its specific geometry; i.e., the border size, the opening geometry and size, etc. There are thousands of different mat boards available in a variety of colors, sizes, textures, and costs. The cost of procuring and storing a complete inventory of all the different mat boards is prohibitive, however. To minimize that cost, framers typically stock some of the more popular mat boards and order the others on demand. At present, mat boards call be delivered within a standard lead time or sooner if the framer is willing, to pay for expedited service and provided the distributor has the desired mat board in stock. Some mat boards are only sold in certain large sizes. If the framer desires a smaller size mat board, he must purchase the larger mat board and cut the desired smaller mat board therefrom. The framer must then either charge the end-user for the larger mat, or carry the difference as an inventory cost.

Most framers use a mechanical mat cutting machines to cut mat boards. Mechanical mat cutting machines work well on simple mat board geometries. As the complexity of the mat board geometry increases, so too does the requisite skill to operate the mat cutting machine. If the framer makes a mistake cutting the mat board, he often must scrap the mat (and therefore assume the cost of the mat) and start over with a new mat board. In addition, manually cutting some of the more complex mat board geometries requires significant operator time; i.e., time in excess of that which can be billed and/or time that could be spent with other customers. Computerized mat cutting machines work well cutting complex mat board geometries. They are, however, typically considerably more expensive than mechanical mat cutting machines and require substantially more floor space than does a mechanical mat cutting machine. As a result, fewer framers opt for computer controlled mat cutting machines.

What is needed, therefore, is a method for supplying framing materials in a timely manner, one that does not require a framer to stock a large variety of framing materials, and one that can provide framing materials to a framer at a reduced risk to the framer.

### DISCLOSURE OF THE INVENTION

It is, therefore, an object of the present invention to provide a method for supplying framing materials in a timely manner, one that does not require a framer to stock a large variety of framing materials, and one that can provide framing materials to the framer at a reduced risk to the framer.

A method for supplying framing materials is provided, comprising the steps of: (a) providing a framer access to a software program for selecting one or more characteristics of a framing supply such as a mat board, wherein the software program is operable to create an electronic file that contains information relating to the one or more characteristics; (b) receiving one or more of the electronic files that contain the information relating to the characteristics of one or more mat boards; (c) preparing the framing material using a computer controlled machine and the one or more electronic files; and (d) providing the framing material to the framer.

An advantage of the present method is that it provides the framer improved access to a large inventory of different types of mat boards or other framing material without having to procure and store that inventory.

Another advantage of the present method is that it permits a framer to produce custom framing materials such as mat boards and frames with a greatly reduced chance of error. At present, if a framer makes a mistake cutting a mat board, he typically has to assume the cost of the damaged mat board. Using the present method, the framer can electronically design a mat board and not make a single cut in the process. The supplier cuts the mat board according to the framer's design and thereby assumes the risk of error heretofore assumed by the framer.

Another advantage of the present method is that it provides framers who presently do not have a computer controlled mat board cutting machine, access to one as needed. As a result, framers who do not have a computer controlled mat board cutting machine can now produce intricate mat board opening designs that heretofore were not practically possible without a computer controlled mat board cutting machine.

Another advantage of the present method is that a framing material design, such as a mat board design, can be produced by the framer without the framer creating scrap. Some mat boards, for example, are only available in large size panels. If a customer desires such a mat board for a small application, the framer must order and pay for the entire board. Because mat boards are often expensive, framers typically either carry the remainder of the mat board (and therefore its cost) as inventory, or scrap the remainder and assume the cost. Using the present method, the framer orders and pays for exactly what he wants.

Another advantage of the present method is that the framer can produce mat board or other framing material designs repeatedly without have to start from scratch. Once a mat board design is stored within a matfile, for example, the design can be used again repeatedly via the matfile. In addition, the present method enables the framer to order large quantities of any particular design without having to repetitively cut mat boards.

Another advantage of the present method is that the framer is able to have a one or more designs expeditiously reviewed and priced by the supplier before an order is placed. The price is determined using the electronic file created by the framer that contains the unique characteristics of the framer's design. Hence, the present method enables the framer to establish a cost prior to ordering, including comparative costs between different framing materials. When the electronic file is uploaded to the supplier's website, the framer can price different framing materials without direct assistance from the supplier.

These and other objects, features, and advantages of the present invention will become apparent in light of the detailed description of the present invention.

### BRIEF DESCRIPTION OF THE DRAWINGS

FIG. 1 is a block diagram illustrating steps within the present method.

FIG. 2 is a representative user screen of the design software for designing a mat board with a single opening.

FIG. 3 is a representative user screen of the design software illustrating the option to select the number of layers within a mat board with a single opening.

FIG. 4 is a representative user screen of the design software illustrating the option to select a decorative feature for a mat board with a single opening.

FIG. 5 is a representative user screen of the design software for designing a mat board with multiple openings.

FIG. 6 is a representative user screen of the design software illustrating the option to select the number of layers within a mat board with multiple openings.

FIG. 7 is a representative user screen of the design software illustrating the option to select a decorative feature for a mat board with multiple openings.

FIG. 8 is a representative user screen of the design software illustrating the option to select positioning of the multiple openings within the mat board.

FIG. 9 is a representative user screen of the design software illustrating the option to select centering of the multiple openings within the mat board.

FIG. 10 is a representative user screen of the design software illustrating the option to select borders for a mat board with multiple openings.

FIG. 11 is a representative user screen of the design software illustrating the option to save a mat board design as a data file.

FIG. 12 is a representative user screen from a web site illustrating the prompt to upload a data file and thereby create a new order.

FIG. 13 is a representative user screen from a web site illustrating the order information.

FIG. 14 is a representative user screen from a web site illustrating the prompt to confirm business information.

FIG. 15 is a representative user screen from a web site illustrating the prompt to confirm an order.

FIG. 16 is a representative user screen from a web site illustrating a receipt indicating confirmation of the order.

### DETAILED DESCRIPTION OF THE INVENTION

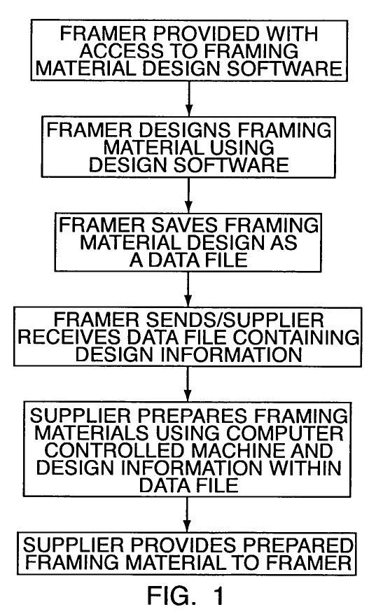

Referring to FIG. 1, a method for supplying framing materials such as custom designed mat boards, frames, fillets, and the like is described herein. It has particular utility for providing customized framing materials to framers or end-users. For simplicity sake, the present method will be described in terms of providing custom mat boards. The present method is not limited to the provision of mat boards, however, and can be used with other framing materials (e.g., frames, fillets, backing boards, transparent panel, etc.). Also for simplicity sake, the term “framer” as used herein includes any party, including an end-user, that is directly or indirectly producing framing for any application, including but not limited to artwork, pictures, signs, or the like.

It is preferable, but not necessary, for the custom framing supplier (“Supplier”) to have an inventory of mat boards that includes a variety of different mat board materials, styles, colors, and textures, and a list of the inventory. The method further includes the use of one or more computer controlled mat cutting machines by the Supplier. Data can be input into the computer controlled mat cutting machine from a data file. An example of an acceptable mat cutting machine is the model F-6100 mat cutting machine manufactured by The Fletcher-Terry Company of Farmington, Connecticut, USA. The mat cutting machine is connected to a computer processing unit (CPU) that can access electronic data files transferred by disk, by modem, by WAN or LAN connection, etc.

Software that is compatible with the computerized mat cutting machine is directly or indirectly provided to a framer. Software can be directly provided, for example, on a disk or CD-ROM, or as a download off of a web site. Software can also be provided indirectly by providing the framer access to a web site that is programmed to accept data input. The software enables the framer to create a data file (hereinafter referred to as a “matfile”) containing desired characteristics of one or more mat boards. The framer inputs data into the matfile by selecting particular mat characteristics including, but not limited to, mat board material, style, color, texture, outer dimensions, opening(s) geometry, and border size. Hence, the framer has the ability to selectively determine custom mat characteristics. Alternatively, the framer can elect to use one or more groups of pre-selected characteristics alone or in combination with other characteristics.

Once the matfile is created, it is electronically transferred from the framer to the remotely located Supplier. In the preferred embodiment, the matfile is transferred to the Supplier by uploading the matfile to an Internet web site affiliated with the Supplier. At the web site, the framer's design is evaluated for requirements. If the requirements are present, a price can be determined using the particular characteristics within the matfile created by the framer. The framer is subsequently prompted to place an order at the web site. The framer is also prompted for customer information; e.g., name, address, shipping address, payment method, etc.

The Supplier receives the order(s) by accessing the web site and downloading the order. The order includes the customer information and the matfile(s). The customer information is utilized to create one or more internal orders within the Supplier's internal system and the matfile as data for the computer controlled mat cutting machine. The matfile is accessed by the mat cutting machine, which uses the data contained therein to create the desired mat board. The cut mat board is subsequently delivered to the framer or other predetermined destination.

As stated above, the present method has particular utility for supplying customized mat boards, but is not limited thereto. It can also be used, for example, to provide customized picture frames made from frame stock.

To enable a full appreciation of the present method, a detailed example of the method is provided below. The detail of the example illustrates well the utility and advantage provided by the present method. The present method is not, however, limited to the details of the example provided.

Example of the Operation of the Method:

The Supplier has an inventory of mat boards that includes a variety of different mat board materials, styles, colors, and textures. The inventory is categorized and identified within an inventory list. The Supplier has one or more computer controlled mat cutting machines; e.g., a Fletcher-Terry model F-6100. The computer controlled mat cutting machine is connected to a CPU. As will be explained below, the CPU is connected to permit electronic communication via the Internet. The Supplier maintains or is affiliated with a web site (e.g., “www.framersolutions.com”) that can be accessed by the framer and the Supplier as will be described below.

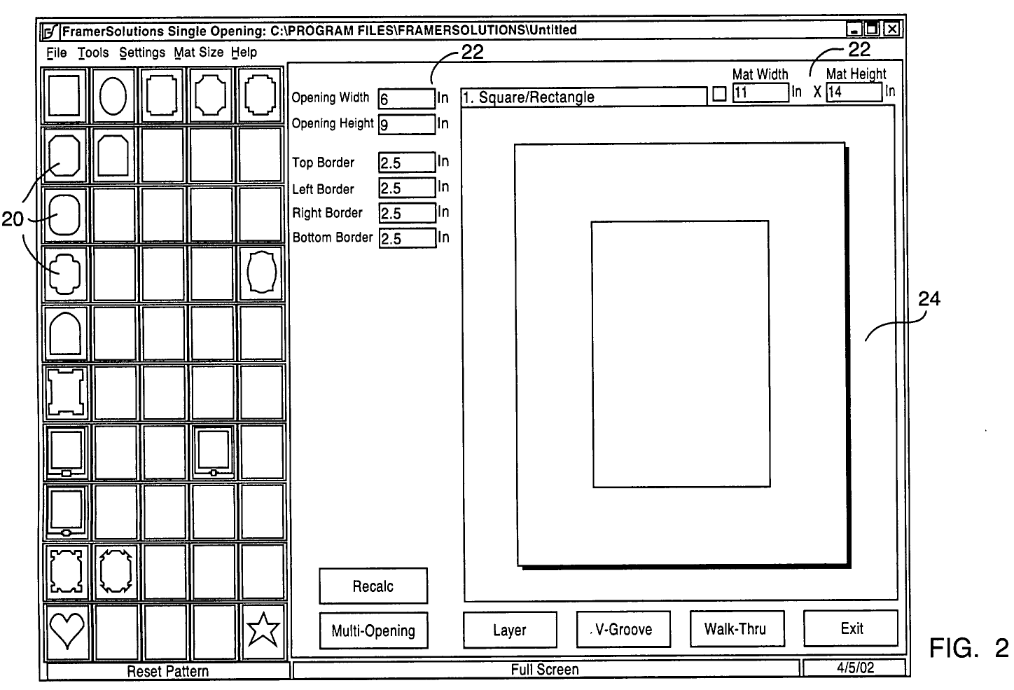

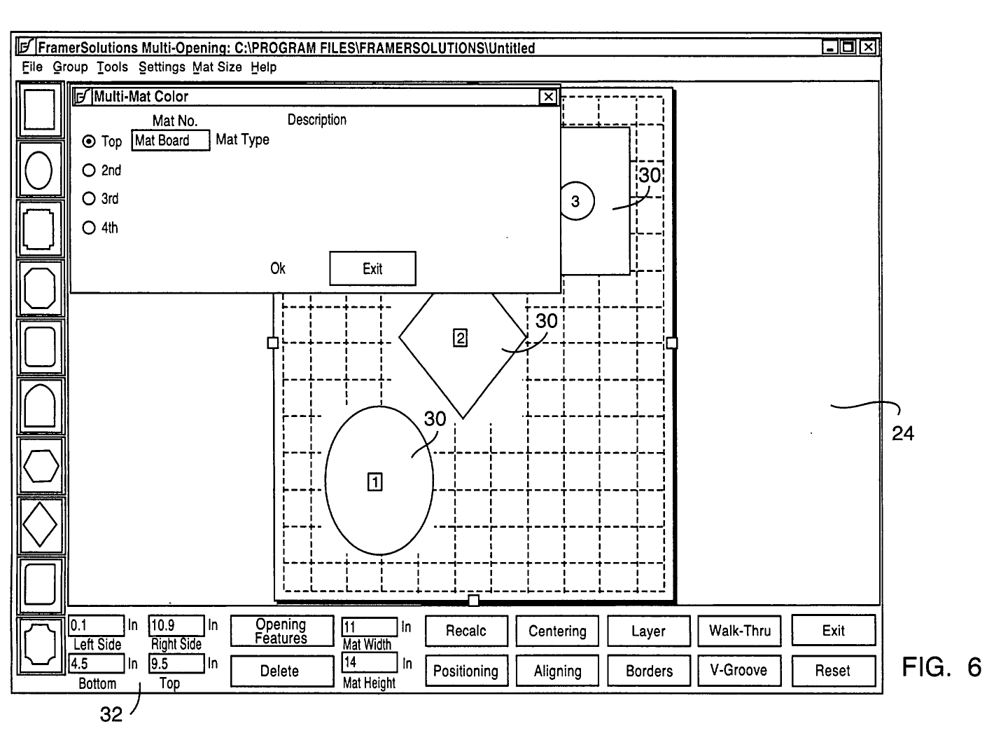

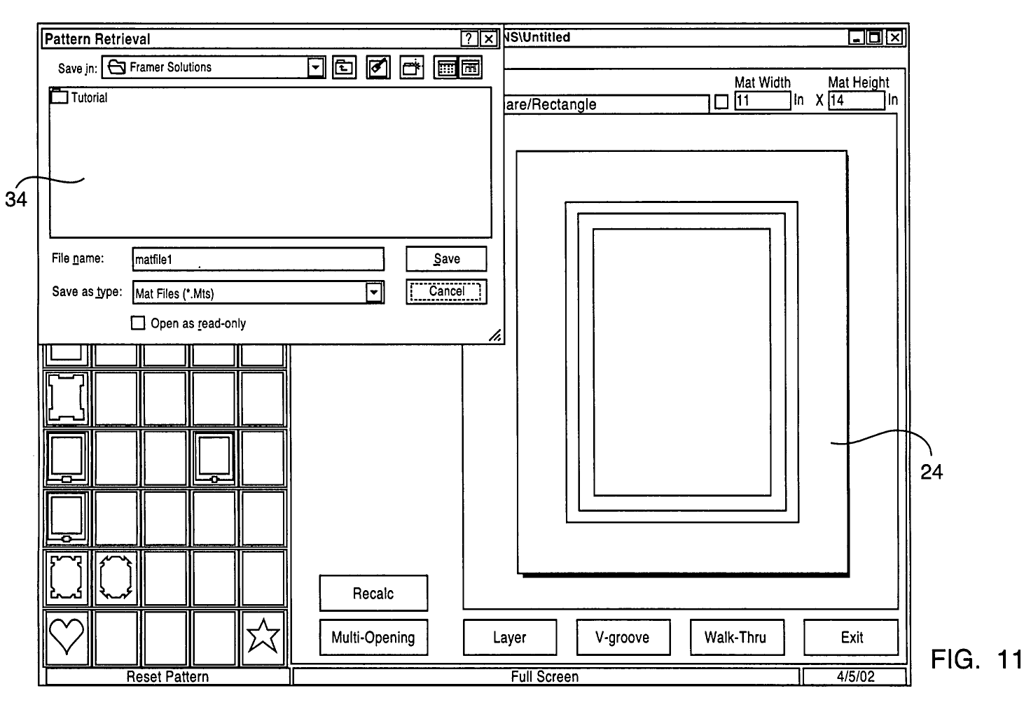

Referring to FIGS. 2-11, software is provided by the Supplier to the framer, for example by disk, CD-ROM, as a download off of Supplier's web site, or for use at the Supplier's web site. The software includes a design program. For ease of use, it is preferred that the design program have a graphic user interface (“GUI”) accessible by the framer. The software provided to the framer is compatible with the CPU connected to the mat cutting machine. The software is operable to create a “matfile” based on data input by the framer as will be described below.

The design program portion of the software initially prompts the framer to choose between designing a single opening mat board or a multiple opening mat board. If the framer elects to design a mat board with a single opening, the program provides the framer with the option of choosing a predetermined opening geometry 20 (or designing a custom opening geometry) as is shown in FIG. 2. If the framer elects to use one of the predetermined geometries 20, the program also provides the user with prompts 22 for information relating to that geometry. For example, if a rectangular opening is selected, the prompts will request information such as the size of the opening width, the opening height, the top, left, right, and bottom borders, and the mat board width and height. As a further example, if an oval opening is selected the prompts request the two axes of the oval (which can also be referred to as the opening width and the opening height), the top, left, right, and bottom borders, and the mat board width and height. Once the requested information is entered by the framer, the program can be run to calculate the dimensions of the mat board. The program includes a visual display 24 illustrating an image of the mat board with the dimensions selected by the framer. The design program can be run any number of times to enable visualization of a variety of opening geometries (e.g., oval, circular, rectangular, etc.) and dimensions.

Note that the dimensional information requested is necessarily interrelated. If a framer provides the opening width and the left and right border dimensions, the mat width will be automatically calculated by summing those dimensions. Conversely, if the mat board width and the opening width are entered by the framer, then the program will determine the borders using the difference between the mat width and the opening width. This feature enables the framer to create a mat board design using a variety of dimensional data inputs.

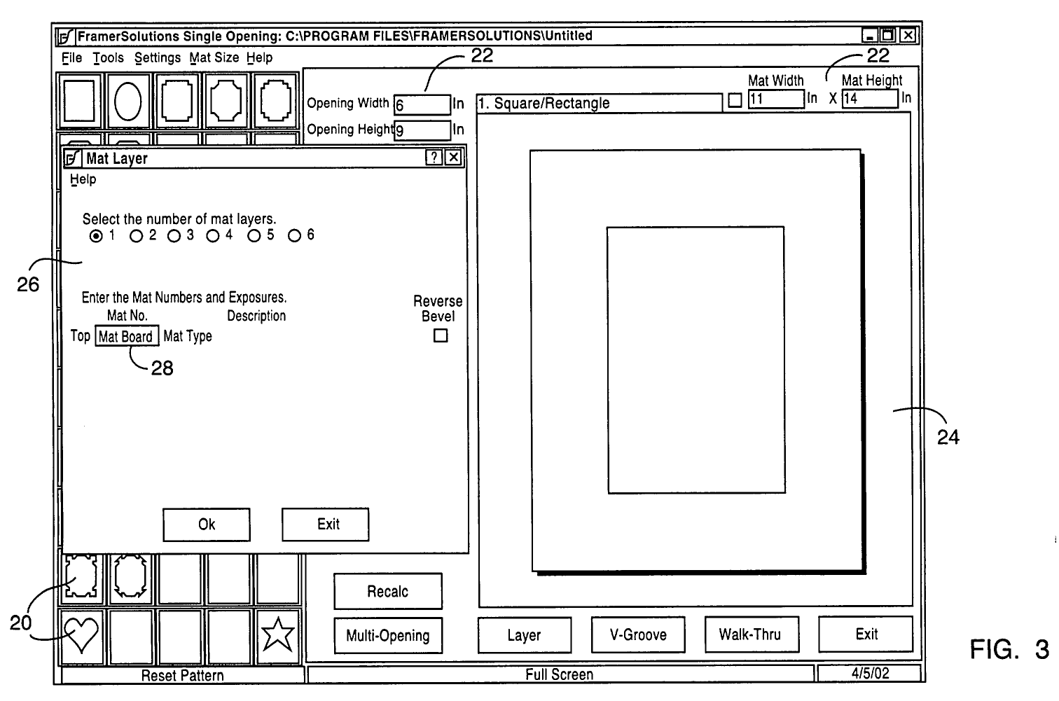

Now referring to FIG. 3, once the framer has selected the mat board dimensions, the design program prompts 26 the framer to elect the number of mat board layers. A single layer mat board will consist of one mat board, a double layer mat board will consist of two mat boards, and so on. If a plurality of mat boards are selected, the program prompts the framer to specify the amount of exposure, if any, between mat boards. For example, in a two layer mat board arrangement with a one-quarter inch exposure, the opening in the top mounted mat board has an opening with the same geometry as the lower mat board, but has an opening geometry that is one-quarter inch greater along each edge of the opening. As a result, one-quarter inch of the lower mat board is exposed around the periphery of its opening. The framer can create a large number of complimentary opening geometries and sizes to create a variety of unique looks. The program also gives the framer the option of making the opening with a bevel cut or a straight cut.

The program further includes a prompt 28 for the framer to specify the type of mat board for each layer of mat board. A person of skill in the art will recognize that mat boards are commercially available in a large variety of different colors, thicknesses, textures, etc. The framer can specify the type of mat board, for example, by entering a predetermined item number associated with a particular mat board. An inventory list identifies the mat boards and provides an item number for each mat board. The inventory list can be provided to the framer by paper copy or can be contained within a portion of the software. Other mechanisms for specifying the mat board can be used alternatively.

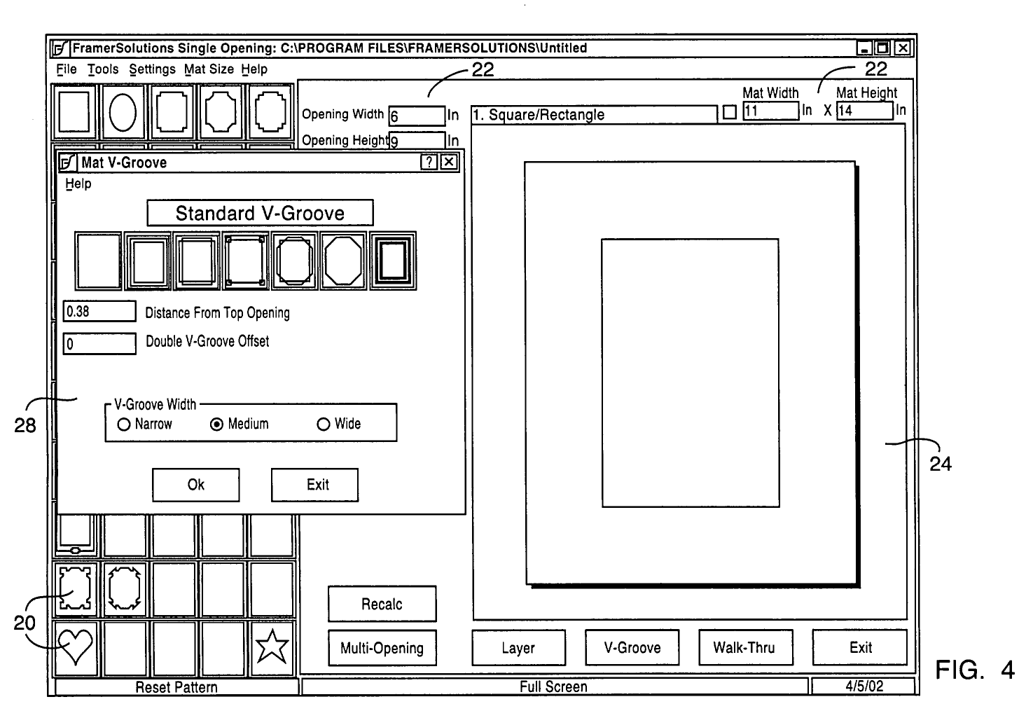

Now referring to FIG. 4, the software preferably gives the framer the further option 28 of adding decorative characteristics such as a V-groove. If a decorative option is selected, the software prompts the framer to supply the relevant details; e.g., the size and location of the detail, the width of the detail, etc.

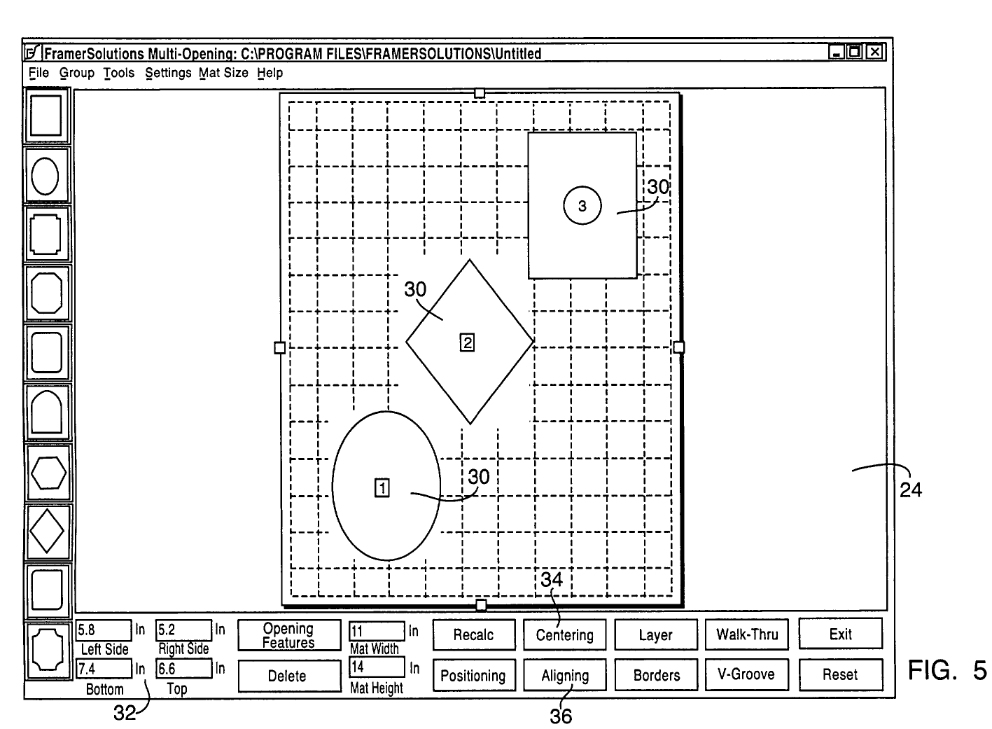

Now referring to FIG. 5, if the framer elects to design a mat board with multiple openings, the program provides the framer with a variety of ways to define the number of openings 30, the geometry of each opening, the size of each opening and the relative positioning of the openings. For example, if the framer desires a mat board having three openings, he can select a predetermined geometry independently for each of the three openings. Once the geometry of an opening is selected, the program prompts the framer to specify the relevant dimensional data for that geometry of that opening in the manner described above. The program also prompts 32 the user to specify the position of that opening 30 within the mat board. The program then permits the framer to adjust relative positions of the openings on the mat board. For example, the openings can be centered 34 or aligned 36 relative to one another. In some embodiments, the program provides the framer with an option to select mat board designs having preconfigured multiple opening arrangements.

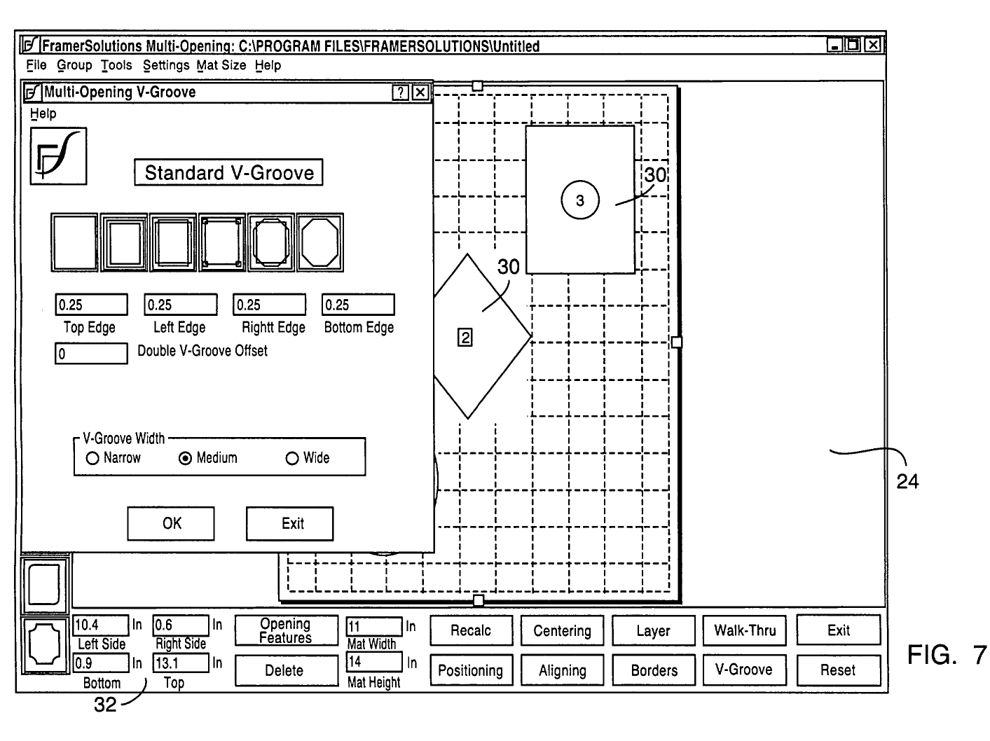

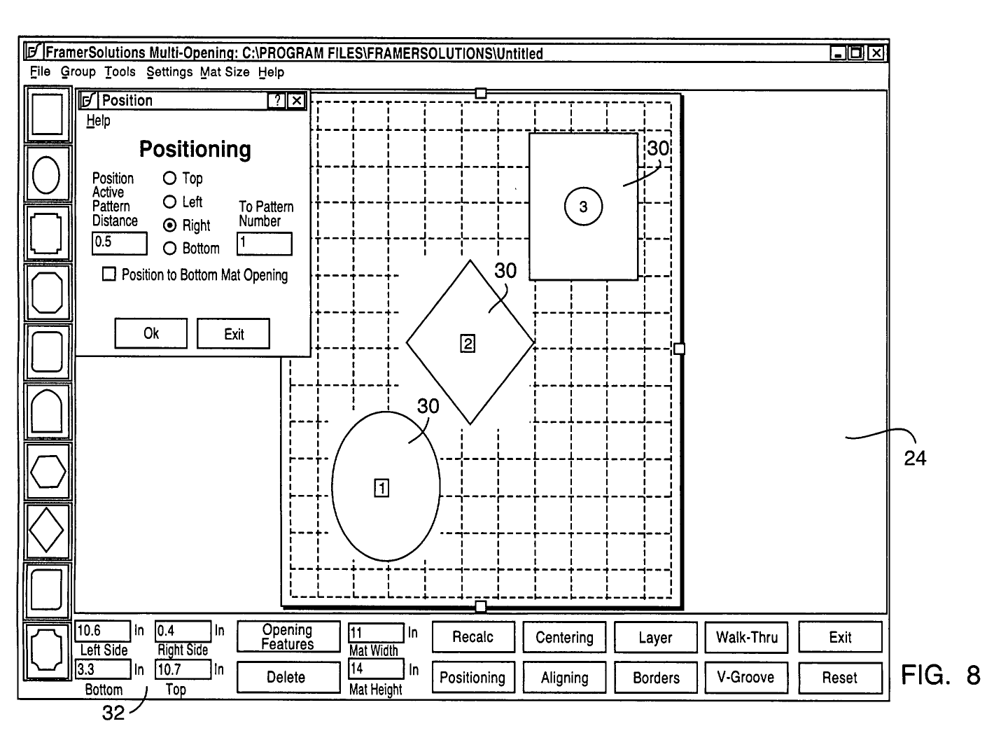

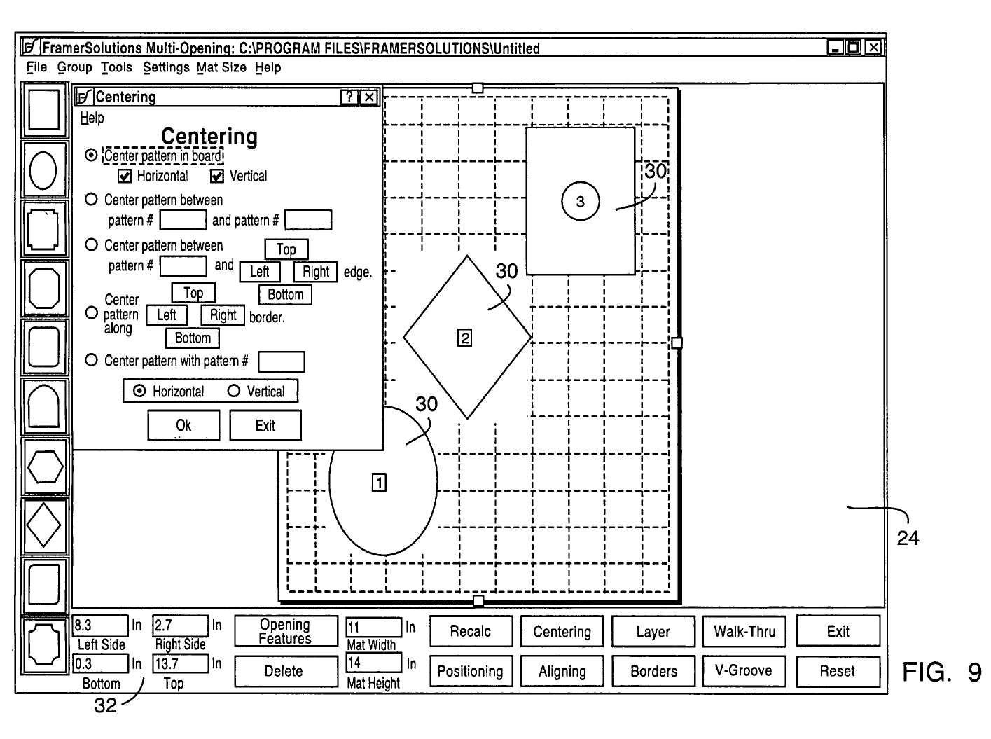

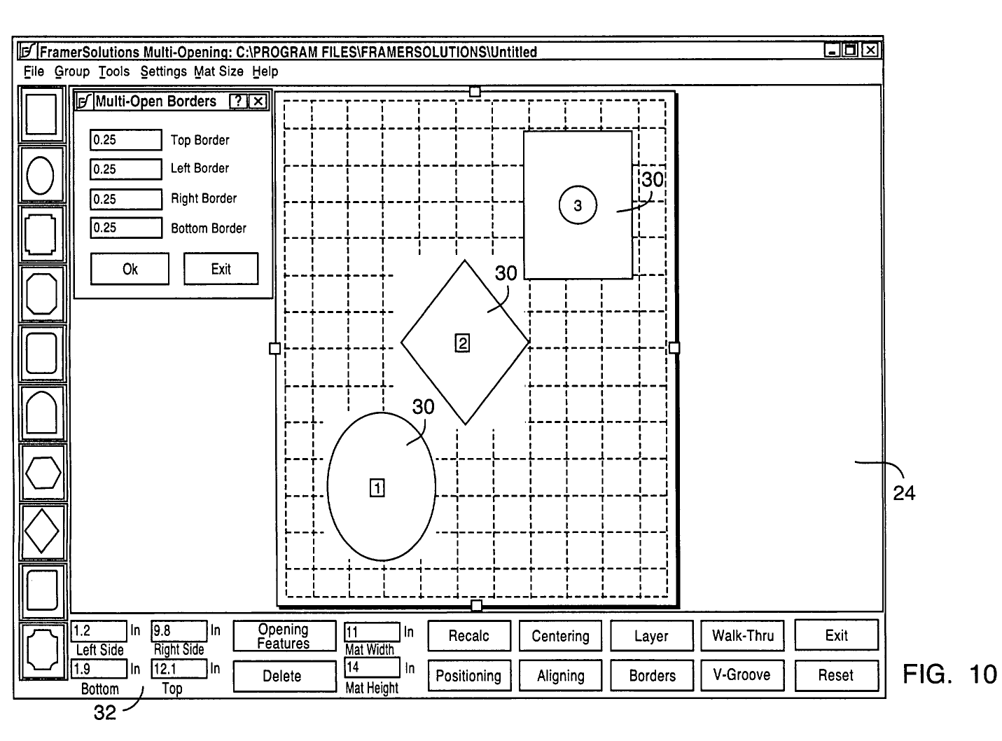

Referring to FIGS. 5-10, after the opening geometries, sizes, and positions are selected, the program prompts the framer to select the number and type of mat board layers, the type of cut (e.g., straight, beveled, etc.) used to create the opening, the decorative characteristics (FIG. 7), positioning (FIG. 8), centering (FIG. 9), borders (FIG. 10), etc. The selection process is the same as or similar to that described above for the mat board with a single opening. Here again, these design options enable the framer to create and visualize a large number of unique mat board designs without cutting a single mat board.

In some instances after the single opening or a multiple opening mat board is designed, the program provides the framer with the option of specifying the quantity desired of the custom designed mat board. If the mat board includes a plurality of layers, the software can also provide the framer with the option of assembling the layered mat board himself, or having it assembled by the Supplier.

The above description of creating a mat board design is an example of how a mat board can be designed. Unless otherwise stated, there is no required order to the steps. Other mat board design techniques may be used alternatively.

Upon completion of the custom mat board design, the design program gives the framer a variety of options including but not limited to: 1) starting over again without saving the mat board design; 2) saving the design as a matfile and quitting the program; 3) saving the design as a matfile and beginning a new design using the above-described process; or 4) saving the design as a matfile and beginning the ordering process.

If the matfile is designed at the Supplier's web site, the ordering process is initiated by the framer accessing an ordering section of the Supplier's web site. If the matfile is designed using software loaded on the framer's computer (i.e., a computer offline of the web site), the ordering process is initiated by the framer accessing the Supplier's web site. After accessing the web site, the framer is prompted to provide a “username” and a password. Framers can utilize the same “username” and password multiple times. The first time a framer “logs” on under a user name, the framer is prompted to provide customer information (e.g., business address, credit card number, mailing address, etc.). If the framer has previously placed orders with the Supplier, the framer is permitted to go directly to the ordering process after logging on to the web site. During the ordering process (as will be detailed below), the framer is prompted to confirm or edit the customer information previously supplied as necessary.

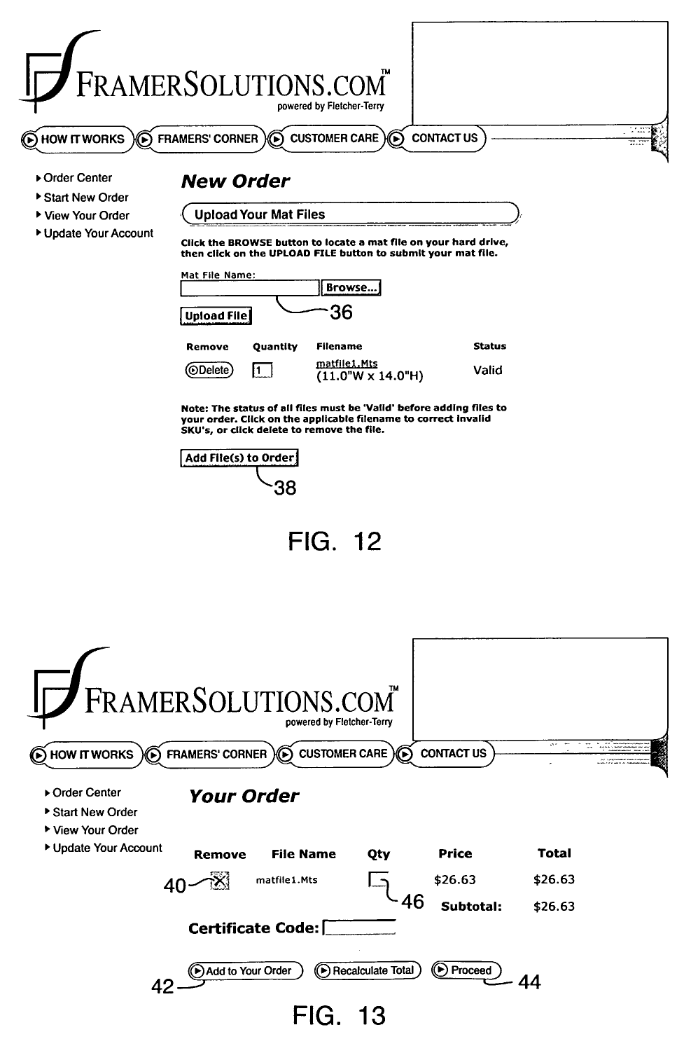

Once in the ordering section of the web site, the programming within the web site (i.e., “web site program”) provides the framer with a variety of options such as starting a new order or viewing an existing order. If a new order is selected (see FIG. 12), the web site program prompts 36 the framer to locate the desired matfile. Locating the desired matfile can be accomplished in a variety of ways and the present method is not limited to any one in particular. For example, the location of the matfile on the hard drive of the framer's computer can be given and the matfile can be uploaded from there.

Once the matfile is transferred from the framer and received at the Supplier's web site, the status of the matfile is verified; e.g., that it can be accessed and it is in usable form. An acknowledgement of the status (e.g., valid, not valid) is provided to the framer. The framer then adds the matfile to an order via a prompt 38. During the process of adding the matfile to the order, the web site program accesses each matfile attached to the order and utilizes the data within that matfile to determine a cost per mat board, and a total cost of the order. The total cost reflects all of the mat boards requested within the order. Once the matfile is added to the order (see FIG. 13), the framer is provided with the cost per mat board, and the total cost of the order. The framer is also given the option of removing 40 the matfile from the order, adding 42 a new matfile to the order, or proceeding 44 with the order in its current state. The web site program also permits the framer to select an order quantity 46 for each of the mat boards contained within the now transferred matfile.

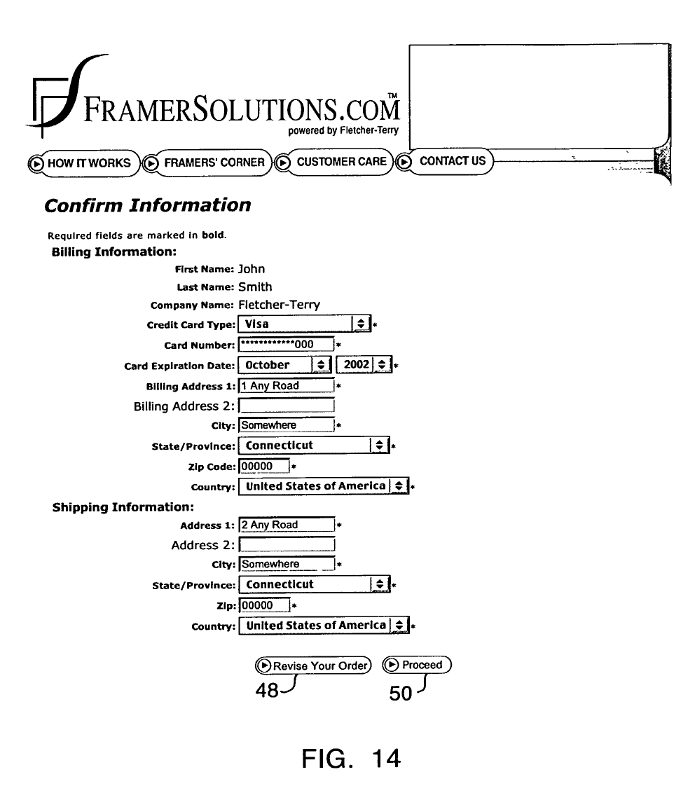

Once the framer has added all of the desired mat boards to the order, the order is submitted to the Supplier's web site. Before the web site accepts the order, the framer is prompted to confirm the customer information previously supplied, or to enter new information where appropriate (see FIG. 14). In the preferred embodiment, the prompts for confirmation of customer information are done in a secure environment (e.g., “https”) since private information including credit card or other payment means is produced. The framer is given the option of revising 48 the order or proceeding 50 with the order.

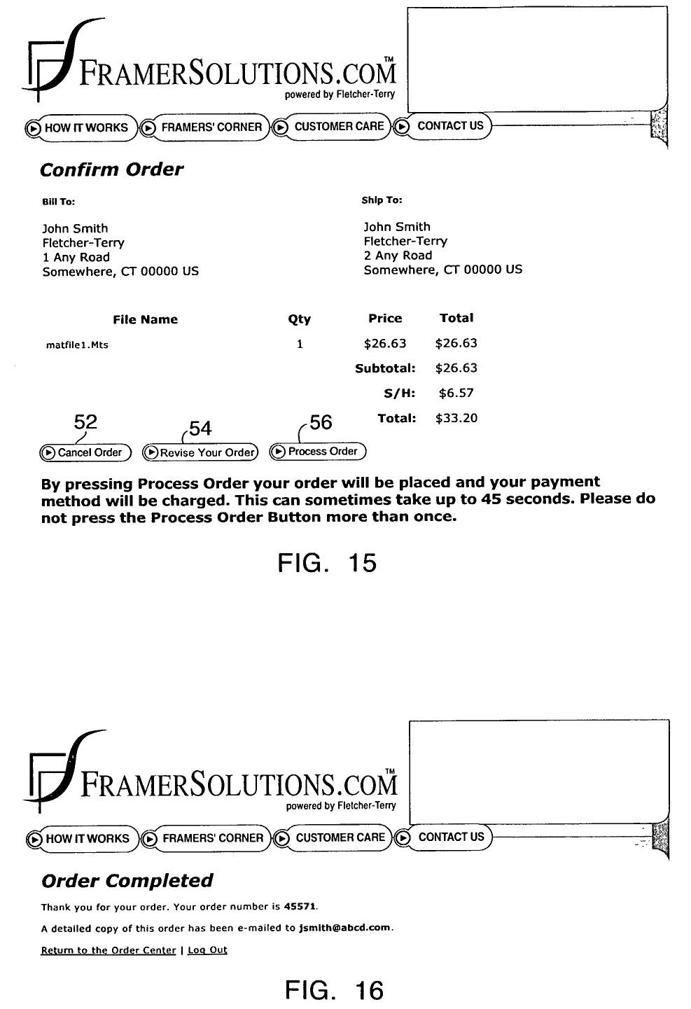

If the framer proceeds with the order and confirms the customer information, the framer is provided with an order confirmation (see FIG. 15) that indicates relevant information such as the matfile name(s) submitted by the framer, the quantity of each mat board requested, the cost per unit of each mat board, the total cost of the mat boards, shipping and handling (if any) based on the billing information, and a total cost for the order. At this point the framer is given the option of canceling 52 the order, revising 54 the order, or finally processing 56 the order. If the framer elects to finally process the order, an acknowledgement that the order has been accepted is provided that indicates an order number and/or other relevant information (see FIG. 16). A record of the order is also sent to the framer via mail or e-mail for his or her records.

The Supplier receives the orders by accessing the web site and downloading the order to Supplier's internal computing system. The downloaded order contains the customer information and the matfile. The customer information is utilized in the creation of one or more internal orders; e.g., a billing order, a make order, etc. The matfile is stored at a location where it can be accessed by the CPU connected to the computer controlled mat cutting machine. The type of mat board and its external dimensions are determined from the information within the matfile. With that information, an appropriate mat board is selected from the Supplier's inventory and mounted on a computer controlled mat cutting machine. The mat cutting machine operator uploads or otherwise accesses the appropriate matfile received from the framer into the control portion of the mat cutting machine. The mat cutting machine then cuts the mat board based on the information within the matfile. When the matfile cut is complete, the operator forwards the finished mat board to be provided to the framer. In some embodiments, the finished mat boards can be picked up at the Supplier. In other instances, the finished mat boards can be shipped to the framer, or other entity if so desired. If desired, a confirmation of shipping can be sent to the framer electronically once the mat board is completed. Once the order is completed, the framer is automatically billed.

Although this invention has been shown and described with respect to the detailed embodiments thereof, it will be understood by those skilled in the art that various changes in form and detail thereof may be made without departing from the spirit and scope of the invention. For example, as stated above, the present method could be applied to other custom framing materials such as frames, fillets, backing boards, transparent panels, etc. Frames and fillets (i.e., elements inserted between mat boards to provide depth) come in a wide variety of styles and colors. The process described above would be used by the framer to determine the specific characteristics of the framing material. As a further example, the above detailed method is not limited to use by a framing business. As indicated above, the present method provides considerable utility for a variety of entities commercial and non-commercial end-users as well as framing businesses. In addition, the above description details the embodiment wherein the framer directly accesses the Supplier software via a storage medium or by downloading it. As indicated above, the framer may also access the software by inputting data via a programmed Supplier web site that is operable to create a matfile; e.g., in the manner described above with respect to the design program portion of the software.

What is claimed is:

1. A method for supplying mat boards, comprising the steps of:
providing a framer access to a software program for selecting one or more characteristics of a mat board, wherein the software program is operable to create an electronic file that contains information relating to the one or more characteristics of one or more mat boards;
receiving one or more of the electronic files, each electronic file containing information that relates to the characteristics of at least one mat board;
preparing one or more mat boards using a computer controlled mat cutting machine and the one or more electronic files received from the framer; and
providing the one or more prepared mat boards to the framer.

2. The method claim 1, wherein the one or more electronic files are received electronically via the Internet.

3. The method claim 2, wherein the one or more electronic files are uploaded to an Internet web site.

4. The method of claim 3, wherein the one or more electronic files are included in an order for the one or more mat boards that includes customer information.

5. The method of claim 4, further comprising the step of:
providing a price for at least one of the one or more mat boards within the order, wherein the price is determined utilizing the information relating to the characteristics of one or more mat boards contained within the one or more of the electronic files.

6. The method of claim 5, further comprising the step of:
providing a total price for all of the one or more mat boards within the order, wherein the total price is determined utilizing the information relating to the characteristics of one or more mat boards contained within the one or more of the electronic files.

7. The method of claim 5, wherein the step of receiving one or more of the electronic files comprises downloading the order for one or more mat boards from the Internet web site.

8. The method of claim 7, wherein the step of preparing one or more mat boards using a computer controlled mat cutting machine and the one or more electronic files received from the framer comprises selecting the one or more mat boards from an inventory.

9. The method of claim 8, wherein the step of preparing one or more mat boards using a computer controlled mat cutting machine and the one or more electronic files received from the framer further comprises cutting the one or more mat boards with the computer controlled mat cutting machine, wherein the computer controlled mat cutting machine cuts the one or more mat boards utilizing the information relating to the characteristics of one or more mat boards.

10. The method of claim 9, wherein the step of providing the one or more mat boards to the framer includes packaging and shipping the one or more mat boards.

11. The method of claim 1, further comprising the step of:
providing a price for at least one of the one or more mat boards within the order, wherein the price is determined utilizing the information relating to the characteristics of one or more mat boards contained within the one or more of the electronic files.

12. The method of claim 11, further comprising the step of:
providing a total price for all of the one or more mat boards within the order, wherein the total price is determined utilizing the information relating to the characteristics of one or more mat boards contained within the one or more of the electronic files.

13. A method for purchasing mat boards, comprising the steps of:
creating a mat board design using a software program for selecting characteristics of a mat board, wherein the characteristics include at least one inner opening of the mat board;
storing the mat board design in an electronic file that contains information relating to the characteristics of one or more mat boards;
logging onto a supplier web site;
uploading one or more of the electronic files that contain the information relating to the characteristics of one or more mat boards to the supplier website; and
placing an order for one or more mat boards.

14. A method for purchasing mat boards, comprising the steps of:
logging onto a supplier web site;
uploading to the supplier's web site one or more electronic files that contain information relating to the characteristics of one or more mat boards, wherein the characteristics include at least one inner opening of the one or more mat boards; and
placing an order for one or more mat boards.

15. A method for supplying framing materials, comprising the steps of:
providing a framer access to a software program for selecting one or more characteristics of a framing material, wherein the software program is operable to create an electronic file that contains information relating to the one or more characteristics of the framing material;
receiving one or more of the electronic files that contain the information relating to the characteristics of the framing material;
preparing one or more framing materials using a computer controlled machine and the one or more electronic files received from the framer; and
providing the one or more prepared framing materials to the framer.

16. The method of claim 15, wherein the framing material is a frame stock.

17. The method of claim 15, wherein the framing material is a fillet.

18. A method for supplying framing materials, comprising the steps of:
receiving one or more electronic files that contain the information relating to characteristics of a framing material;
preparing one or more framing materials using a computer controlled machine and the one or more electronic files received from the framer; and
providing the one or more prepared framing materials to the framer.
